(19) United States
(12) Patent Application Publication
(10) Pub. No.: US 2025/0254645 A1
(43) Pub. Date: Aug. 7, 2025

(54) Apparatus Comprising at Least One Processor

(71) Applicant: Nokia Technologies Oy, Espoo (FI)

(72) Inventors: Maximilian Arnold, Murrhardt (DE); Dragan Samardzija, Highland, NJ (US)

(21) Appl. No.: 18/880,875

(22) PCT Filed: Jul. 7, 2022
(86) PCT No.: PCT/EP2022/068848

§ 371 Date: Jan. 3, 2025

(51) Int. Cl. H04W 64/00

(52) U.S. Cl. CPC H04W 64/00

(57) ABSTRACT

An apparatus, including at least one processor, and at least one memory storing instructions, the at least one memory and the instructions configured to, with the at least one processor, cause a first device to determine a position of the first device, and to determine a plurality of transmitter devices configured to transmit radio frequency signals in a region associated with the position of the first device.

### FIELD OF THE DISCLOSURE

Various example embodiments relate to an apparatus comprising at least one processor.

Further embodiments relate to a method of operating related to such apparatus.

### BACKGROUND

The 5th generation (5G) of mobile communication drove communication networks to physical performance bounds e.g. regarding latency, throughput and spectral efficiency. The next generation (6G) may further extend communication networks, e.g. by sensing capabilities.

### SUMMARY

Various embodiments of the disclosure are set out by the independent claims. The exemplary embodiments and features, if any, described in this specification, that do not fall under the scope of the independent claims, are to be interpreted as examples useful for understanding various exemplary embodiments of the disclosure.

Some exemplary embodiments relate to an apparatus, comprising at least one processor, and at least one memory storing instructions, the at least one memory and the instructions configured to, with the at least one processor, cause a first device to determine a position of the first device, and to determine a plurality of transmitter devices configured to transmit radio frequency signals in a region associated with the position of the first device. In some exemplary embodiments, this may help to enable sensing procedures, e.g. based on the radio frequency signals, e.g. for passively and/or opportunistically reconstructing features, e.g. main features, of an environment as e.g. characterized by the region associated with the position of the first device.

In some exemplary embodiments, a geometrical reconstruction of the environment may be performed and may be used, e.g. to allow different entities to maneuver safely in different environments, e.g. drones or autonomous vehicles. The geometric reconstruction enabled by exemplary embodiments is based on the radio frequency (RF) signals, which enables to sense e.g. a state of the environment comparatively precisely.

In some exemplary embodiments, the apparatus may be an apparatus for a wireless communications network, e.g. according to the 5G and/or 5G Advanced and/or 6G type or of other types. In some embodiments, the apparatus and/or its functionality may e.g. be provided at a terminal device, e.g. user equipment, e.g. for a cellular communications network. In some exemplary embodiments, the first device may be a terminal device or a device for a terminal device. In some exemplary embodiments, this way, joint communication and sensing may be enabled.

In some exemplary embodiments, at least some transmitter devices of the plurality of transmitter devices may e.g. be network devices, e.g. for a wireless communications network, e.g. according to the 5G and/or 5G Advanced and/or 6G type or of other types, e.g. base stations, e.g. gNB.

In some exemplary embodiments, at least some transmitter devices of the plurality of transmitter devices may e.g. be terminal devices, e.g. for a wireless communications network, e.g. according to the 5G and/or 5G Advanced and/or 6G type or of other types, e.g. stationary terminal devices or terminal devices with a known position.

In some exemplary embodiments, sensing procedures based on radio frequency signals transmitted by a plurality of network devices such as e.g. gNB of a wireless communications network may be used, e.g. for passively and/or opportunistically reconstructing features, e.g. main features, of an environment as e.g. characterized by the region associated with the position of the first device.

In some exemplary embodiments, the first device may e.g. listen to, e.g. determine, radio frequency signals, e.g. reference signal transmissions, transmitted by the plurality of network devices such as e.g. gNB. In some embodiments, the first device may determine a more precise position of itself, e.g. improving a precision of its own position as e.g. initially determined, based on the received radio frequency signals, e.g. reference signal transmissions, received from the plurality of network devices such as e.g. gNB.

In some exemplary embodiments, determining the position of the first device may e.g. be performed using a positioning system, e.g. a satellite-based positioning system, e.g. GPS. In other words, in some embodiments, initially, the position of the first device may e.g. be performed using GPS or another positioning system, e.g. according to some accepted standard. In further exemplary embodiments, the initially determined position may be further refined, e.g. based on the received radio frequency signals, e.g. reference signal transmissions, received from the plurality of network devices such as e.g. gNB.

In some exemplary embodiments, the determination and/or refinement of the position of the first device is a non-cooperative procedure or approach, respectively, because the first device determines “passively”, e.g. “scans passively”, i.e. without the knowledge of the plurality of transmitter devices, e.g. network devices.

In other words, some exemplary embodiments exploit radio frequency signals, e.g. reference signals according to some accepted standard, as transmitted from e.g. surrounding transmitter devices, e.g. conventional transmitter devices, e.g. network devices, e.g. for determining and/or refining the position of the first device.

In some exemplary embodiments, the first device may listen, e.g. greedily, e.g., using an arbitrary number of radio frequency signals, e.g. reference signals, as may e.g. be received by the first device from one or more surrounding transmitter devices. In some exemplary embodiments, the so received radio frequency signals may e.g. be used for sensing and/or localization, e.g. refining a position of the first device, e.g. using knowledge about the position of at least some of the one or more surrounding transmitter devices.

Thus, in some exemplary embodiments, the first device may listen, e.g. greedily, e.g. on reference channels of surrounding transmitter devices, to perform a self-localization and/or to refine the position of the first device (as e.g. determined by GPS or some other positioning system), based on the radio frequency signals received from the surrounding transmitter devices and their position, which may e.g. be determined according to some exemplary embodiments, see for example the following paragraph.

In some exemplary embodiments, determining the plurality of transmitter devices comprises determining a respective position of the plurality of transmitter devices. In some embodiments, this e.g. enables to determine base stations and/or other transmitter devices in the region of the first device, e.g. surrounding base stations and/or other transmitter devices and their respective position.

In some exemplary embodiments, it is proposed to determine, e.g. measure, the position of the plurality of transmitter devices using, for example precise, real-time-kinematic (RTK) devices.

In some exemplary embodiments, a library or database may be created comprising the so determined position(s) of the plurality of transmitter devices.

In some exemplary embodiments, the library or database may e.g. be accessible over a control channel of e.g. a network device, e.g. base-station, e.g. of the communication network.

In some exemplary embodiments, a service for providing access to the library or database may be provided, e.g. creating a respective service for multiple device vendors.

In some exemplary embodiments, the information characterizing the position(s) of the plurality of transmitter devices may e.g. be organized in the form of a list.

In some exemplary embodiments, one way to create such list may comprise e.g. a base station to transmit, e.g. on a control channel, e.g. periodically, e.g. its capabilities, e.g. regarding at least one of a) the positions, b) frequency bands, c) corresponding bandwidths.

In some exemplary embodiments, the list may e.g. be available to the apparatus and/or the first device.

In some exemplary embodiments, the instructions, when executed by the at least one processor, cause the first device to determine a selected subset of the plurality of transmitter devices based on at least one of: a) a sub-region associated with a respective transmitter device, b) a frequency associated with a respective transmitter device. In some exemplary embodiments, this enables to perform a pre-selection of the plurality of transmitter devices regarding the respective criteria. As an example, in some exemplary embodiments, only some, e.g. certain, but e.g. not all, transmitter devices, e.g. base stations, within the region may see a specific object, e.g. scatterer, a position of which may, in some exemplary embodiments, be determined based on the radio frequency signals. Thus, in some exemplary embodiments, a decision metric may be used, e.g. defining which sub-regions of the region to be considered, e.g. scanned (e.g. for scattered radio frequency signals), e.g. for determining the position of the scatterer.

In some exemplary embodiments, capabilities of the transmitter devices such as e.g. a bandwidth and a frequency may determine, e.g. decide, how precise e.g. a related distance can be determined, e.g. estimated. Thus, in some exemplary embodiments, it is proposed to use an iterative metric, e.g. to predict a possible scanning precision for evaluating potentially scattered radio frequency signals as may e.g. be received by the first device.

In some exemplary embodiments, e.g. based on the bandwidth-related and/or the frequency-related capabilities of the transmitter devices, a usefulness of specific transmitter devices, e.g. for performing sensing and/or determining and/or refining the position of the first device, may be determined, e.g. prior to evaluating the radio frequency signals received from the transmitter devices. In some embodiments, this way, the selected subset may be determined, e.g. regarding the usefulness of specific transmitter devices, e.g. for performing sensing and/or determining and/or refining the position of the first device, whereby, in some embodiments, an even more precise sensing and/or self-localization of the first device may be enabled.

In some exemplary embodiments, the instructions, when executed by the at least one processor, cause the first device to determine at least one distance associated with at least one of the plurality of transmitter devices based on channel information characterizing at least one radio channel associated with at least one of the plurality of transmitter devices.

In some exemplary embodiments, the determination of the at least one distance associated with at least one of the plurality of transmitter devices may e.g. be based on channel state information, CSI, as may e.g. be evaluated according to some accepted standard. In other words, in some exemplary embodiments, distance estimations related to a distance between a respective transmitter device and the first device may e.g. be made based on CSI associated with radio frequency signals received by the first device from the respective transmitter device.

In some exemplary embodiments, the determination of the at least one distance associated with at least one of the plurality of transmitter devices may e.g. be characterized by the following equation

$${( F )}_{k , l} = {\sum }_{h = 0}^{H - 1} {b}_{h} {e}^{j 2 π {lT}_{O} {f}_{D , h}} {e}^{- j 2 π k {τ}_{h} Δ f} {e}^{j {φ}_{h}} + {( Z )}_{k , l} ,$$

wherein h characterizes a multipath component (e.g., a ray from transmitter to receiver), wherein H characterizes a maximum number of paths, wherein (F)_{k,l} characterizes channel state information associated with a k-th subcarrier and an l-th OFDM symbol, wherein (Z)_{k,l} characterizes additive white Gaussian noise at subcarrier k and symbol l, wherein bₕ characterizes an effective amplitude comprising information related to a path loss and reflection coefficients, wherein e^{j2πlT}^{_{O}}^{f}^{_{D,h}} characterizes a phase shift over OFDM symbols due to movement (e.g., Doppler frequency f_{D}), wherein e^{-j2πkτ}^{ₕ}^{Δf} characterizes a phase shift over subcarriers with subcarrier spacing Δf, wherein e^{jφh} characterizes a random phase offset due to misalignment between a transmitter and a receiver.

In some exemplary embodiments, it can be seen that a range or distance causes a linear phase shift over subcarriers of the radio frequency signals, and the range or distance may e.g. be determined, e.g. estimated, over phase-shifts over the subcarriers. Note that in some exemplary embodiments, the distance may be impacted, e.g. by imperfect time synchronization, e.g. between one or more transmitter devices and a receiver of the first device.

In some exemplary embodiments, the instructions, when executed by the at least one processor, cause the first device to perform at least one of: a) partitioning the region associated with the position of the first device into a plurality of sub-regions, e.g. quadrants, e.g. four quadrants arranged around a reference position as e.g. defined by the position of the first device, b) mapping at least some transmitter devices of the plurality of transmitter devices to at least one sub-region (e.g., quadrant) of the plurality of sub-regions.

In some exemplary embodiments, quadrants may be created or defined by defining a reference point, e.g. focus point, in the first device, and by mapping the transmitter devices accordingly. In some exemplary embodiments, the procedure may involve one or more of the following aspects:
a) determine, e.g. calculate, distance vectors d=p−L.position, where L.position characterizes a position of a specific transmitter device, as e.g. comprised within a list L of transmitter devices, e.g. base stations,
b) map the transmitter devices to the different quadrants by quadrant 1: d.x>0 and d.y>0 (e.g., if a component d.x of the distance vector d is greater than zero and a component d.y of the distance vector d is greater than (or equal to) zero, assign the respective transmitter device to the first quadrant), quadrant 2: d.x<0 and d.y>0 (e.g., if the component d.x is less than zero and the component d.y is greater than zero, assign the respective transmitter device to the second quadrant), quadrant 3: d.x<0 and d.y<0 (e.g., if the component d.x is less than zero and the component d.y is less than zero, assign the respective transmitter device to the third quadrant), quadrant 4: d.x>0 and d.y<0 (e.g., if the component d.x is greater than zero and the component d.y is less than zero, assign the respective transmitter device to the fourth quadrant).

In some exemplary embodiments, e.g. for scanning a certain quadrant, a list of quadrants +1 (e.g. 0-90° is quadrant 1) is used. Further within the list of quadrants, in some exemplary embodiments, a scanning method can be implemented by calculating corresponding angles alpha per reflection point and filtering, e.g. based on their quadrant matching (e.g. 0-90° is quadrant 1).

In some exemplary embodiments, the instructions, when executed by the at least one processor, cause the first device to perform at least one of: a) determining, for at least one sub-region (e.g., quadrant) of the plurality of sub-regions, frequency differences associated with at least some transmitter devices of the specific sub-region, b) sorting the at least some transmitter devices of the specific sub-region by an ascending frequency difference (thus e.g. obtaining a sorted list wherein a first entry of the sorted list corresponds with a minimum frequency difference), c) selecting a predetermined number of N many transmitter devices associated with the N smallest frequency distances, d) sorting the N many selected transmitter devices by a descending maximum available bandwidth (thus e.g. obtaining a sorted list wherein a first entry of the sorted list corresponds with the greatest maximum available bandwidth).

In some exemplary embodiments, the instructions, when executed by the at least one processor, cause the first device to determine whether the bandwidths associated with the N many selected transmitter devices are smaller than a predetermined threshold bandwidth, which is e.g. associated with a desired spatial resolution. In some exemplary embodiments, a parameter m may be determined, e.g. according to m=bandwidth*spatial resolution/speed of light, wherein the parameter m characterizes whether the bandwidths associated with the N many selected transmitter devices are smaller than the predetermined threshold bandwidth with respect to the desired spatial resolution.

In some exemplary embodiments, e.g. if it is determined that the bandwidths associated with the N many selected transmitter devices are smaller than the predetermined threshold bandwidth with respect to the desired spatial resolution, at least some aspects of the procedure explained above for a first sub-region, e.g. quadrant, may e.g. be performed for at least one further sub-region, e.g. quadrant.

In some exemplary embodiments, the instructions, when executed by the at least one processor, cause the first device to calibrate the at least one distance based on a respective position of the plurality of transmitter devices to obtain at least one calibrated distance.

In some exemplary embodiments, the calibration may be an in-situ calibration, e.g. comprising at least some of the following aspects:
a) providing the determined distances between a respective one of the N many selected transmitter devices and the first device,
b) using a, for example conventional, technique to estimate a range of all taps exploiting a phase shift over subcarriers, e.g. a technique based on a MUSIC (MUltiple SIgnal Classification) algorithm for estimating ranges of all taps, e.g. according to https://en.wikipedia.org/wiki/MUSIC_(algorithm) (or, as an example, another technique for probing a noise subspace of a signal, e.g. by using a singular value decomposition (SVD)),
c) shifting a spectrum associated with the MUSIC algorithm by a first range to match the at least one distance,
d) providing a combination of distances as obtained from the preceding steps a), b), c), e.g. for a geometric reconstruction, e.g. for determining a position of at least one scatterer scattering the radio frequency signals.

In some exemplary embodiments, e.g. related to an in situ-calibration, since a position associated with a transmitter and a receiver is known, a line-of-sight path can be filtered, e.g. in such a way that its phases/range matches the expected distance.

In some exemplary embodiments, the instructions, when executed by the at least one processor, cause the first device to determine a position of at least one scatterer scattering at least some of the radio frequency signals in the region based on the at least one calibrated distance. In some exemplary embodiments, it is also possible to determine a position of several, e.g. all, scatterers scattering at least some of the radio frequency signals in the region based on the at least one calibrated distance.

In some exemplary embodiments, a first algorithm (“Algorithm 1”) may be used, e.g. for solving a nonlinear least-squares problem, e.g. via a gradient-descent based method, e.g. with various initializations, and a solution with the minimum related cost may be selected. In some exemplary embodiments, it is expected that Algorithm 1 may be tolerant with respect to noise.

In some exemplary embodiments, aspects of Algorithm 1 may be characterized by the expression

$${min}_{p} {\sum }_{i = 1}^{{N}_{TX}} {\vert f ( p , {t}_{i} , r , {d}_{i} ) \vert}^{2} ,$$

wherein the expression

$${\sum }_{i = 1}^{{N}_{TX}} {\vert f ( p , {t}_{i} , r , {d}_{i} ) \vert}^{2}$$

characterizes the related cost.

In some exemplary embodiments, a second algorithm (“Algorithm 2”) may be used, which may e.g. comprise at least some of the following aspects:
a) determine, e.g. analytically compute, an intersection of at least one pair of ellipses, e.g. of every pair of ellipses, associated with a potential scatterer,
b) determine N_{TX} N_{TX}−1 NSC₂ candidate points, including N_{TX} N2TX−1 points near a true position of each scatterer, wherein N_{TX} is a number of transmit signals capture, and wherein NSC2 is a number of reflection points in a channel,
c) for at least some, e.g. every, candidate point, determine, e.g. compute, a cost for every possible range combination,
d) then, for NSC many times:
d1) pick a point p* with minimum cost c*
d2) return an average of p* and its NTX NTX−1−1 nearest neighbors.

Further exemplary embodiments relate to an apparatus comprising means for determining, by a first device, a position of the first device, and for determining, by the first device, a plurality of transmitter devices configured to transmit radio frequency signals in a region associated with the position of the first device. In some exemplary embodiments, the means for determining, by the first device, a position of the first device, and for determining, by the first device, a plurality of transmitter devices configured to transmit radio frequency signals in a region associated with the position of the first device may e.g. comprise at least one processor, and at least one memory storing instructions, the at least one memory and the instructions configured to, with the at least one processor, cause a first device to determine a position of the first device, and to determine a plurality of transmitter devices configured to transmit radio frequency signals in a region associated with the position of the first device.

Further exemplary embodiments relate to a mobile device comprising at least one apparatus according to the embodiments.

Further exemplary embodiments relate to a method comprising: determining, by a first device, a position of the first device, and determining, by the first device, a plurality of transmitter devices configured to transmit radio frequency signals in a region associated with the position of the first device.

Further exemplary embodiments relate to a system comprising at least one of: a) an apparatus according to the embodiments, b) at least one transmitter device configured to transmit radio frequency signals in the region associated with the position of the first device.

In some exemplary embodiments, the system is a wireless communications system, wherein the apparatus is associated with or configured as a terminal device for the wireless communications system, and wherein the at least one transmitter device is at least one of a) a network device and b) a terminal device for the wireless communications system.

Further exemplary embodiments relate to a computer program or computer program product comprising instructions which, when the program is executed by a computer, cause the computer to carry out the method according to the embodiments.

Further exemplary embodiments relate to a data carrier signal carrying and/or characterizing the instructions according to the embodiments, wherein the instructions may e.g. be provided in the form of at least one computer program.

### BRIEF DESCRIPTION OF EXEMPLARY FIGURES

FIG. 1 schematically depicts a simplified block diagram according to some embodiments,

FIG. 2 schematically depicts a simplified block diagram according to some embodiments,

FIG. 3 schematically depicts a simplified flow chart according to some embodiments,

FIG. 4 schematically depicts a simplified block diagram according to some embodiments,

FIG. 5 schematically depicts a simplified block diagram according to some embodiments,

FIG. 6 schematically depicts a simplified flow chart according to some embodiments,

FIG. 7 schematically depicts a simplified flow chart according to some embodiments,

FIG. 8 schematically depicts a simplified flow chart according to some embodiments,

FIG. 9 schematically depicts a simplified flow chart according to some embodiments,

FIG. 10 schematically depicts an exemplary ellipse associated with an estimated range of a scatterer according to some embodiments,

FIG. 11A schematically depicts a simplified diagram according to some embodiments,

FIG. 11B schematically depicts a simplified diagram according to some embodiments,

FIG. 12 schematically depicts a simplified block diagram according to some embodiments.

### DESCRIPTION OF SOME EXEMPLARY EMBODIMENTS

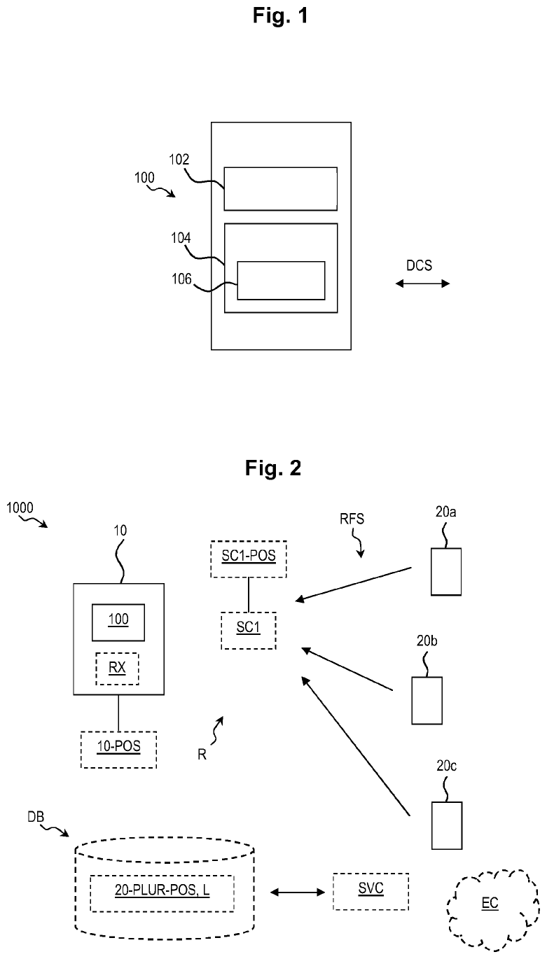

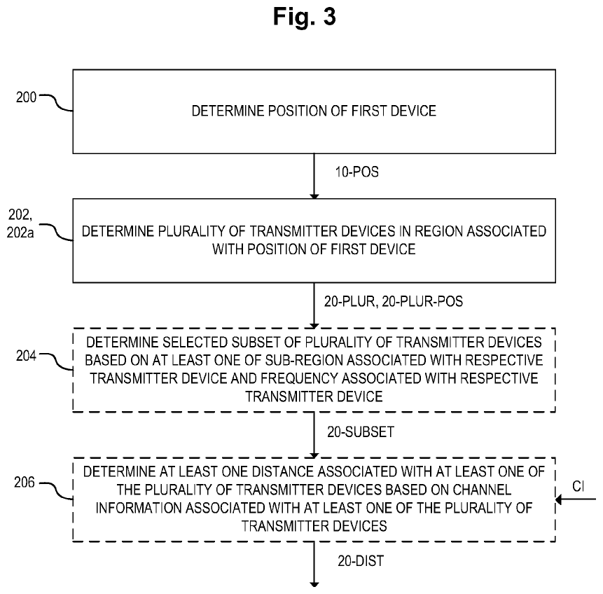

Some exemplary embodiments, see FIG. 1, relate to an apparatus 100, comprising at least one processor 102, and at least one memory 104 storing instructions 106, e.g. in form of at least one computer program, the at least one memory 104 and the instructions 106 configured to, with the at least one processor 102, cause a first device 10 (FIG. 2) to determine 200 (FIG. 3) a position 10-POS of the first device 10, and to determine 202 a plurality 20-PLUR of transmitter devices 20a, 20b, 20c (FIG. 2) configured to transmit radio frequency signals RFS in a region R associated with the position 10-POS of the first device 10. In some exemplary embodiments, this may help to enable sensing procedures, e.g. based on the radio frequency signals RFS, e.g. for passively and/or opportunistically reconstructing features, e.g. main features, of an environment as e.g. characterized by the region R associated with the position 10-POS of the first device 10.

In some exemplary embodiments, FIG. 1, the apparatus 100 may be an apparatus for a wireless communications system 1000, e.g. network, e.g. according to the 5G and/or 5G Advanced and/or 6G type or of other types. In some embodiments, the apparatus 100 and/or its functionality may e.g. be provided at a terminal device, e.g. user equipment, e.g. for a cellular communications network. In some exemplary embodiments, the first device 10 may be a terminal device or a device for a terminal device. In some exemplary embodiments, this way, joint communication and sensing may be enabled.

In some exemplary embodiments, at least some transmitter devices 20a, 20b, 20c of the plurality of transmitter devices may e.g. be network devices, e.g. for a wireless communications network, e.g. according to the 5G and/or 5G Advanced and/or 6G type or of other types, e.g. base stations, e.g. gNB.

In some exemplary embodiments, at least some transmitter devices (not shown) of the plurality of transmitter devices may e.g. be terminal devices, e.g. for a wireless communications network, e.g. according to the 5G and/or 5G Advanced and/or 6G type or of other types, e.g. stationary terminal devices or terminal devices with a known position.

In some exemplary embodiments, FIG. 3, determining 200 the position 10-POS of the first device 10 may e.g. be performed using a positioning system, e.g. a satellite-based positioning system, e.g. GPS.

In some exemplary embodiments, FIG. 3, determining 202 the plurality 20-PLUR of transmitter devices 20a, 20b, 20c, . . . comprises determining 202a a respective position 20-PLUR-POS of the plurality 20-PLUR of transmitter devices. In some embodiments, this e.g. enables to determine base stations and/or other transmitter devices in the region R of the first device 10, e.g. surrounding base stations and/or other transmitter devices and their respective position, which may e.g. be used for sensing, e.g. determining a position SC1-POS of objects such as scatterers SC1.

In some exemplary embodiments, it is proposed to determine, e.g. measure, the position of the plurality 20-PLUR of transmitter devices using, for example precise, real-time-kinematic (RTK) devices.

In some exemplary embodiments, FIG. 2, a library or database DB may be created comprising the so determined position(s) of the plurality 20-PLUR of transmitter devices.

In some exemplary embodiments, the library or database DB may e.g. be accessible over a control channel of e.g. a network device, e.g. base-station, e.g. of the communication network 1000.

In some exemplary embodiments, a service SVC for providing access to the library or database DB may be provided, e.g. creating a respective service for multiple device vendors (not shown).

In some exemplary embodiments, the information characterizing the position(s) 20-PLUR-POS of the plurality of transmitter devices may e.g. be organized in the form of a list L.

In some exemplary embodiments, one way to create such list L may comprise e.g. a base station 20a to transmit, e.g. on a control channel, e.g. periodically, e.g. its capabilities, e.g. regarding at least one of a) the positions, b) frequency bands, c) corresponding bandwidths.

In some exemplary embodiments, the list L may e.g. be available to the apparatus 100 and/or the first device 10.

In some exemplary embodiments, FIG. 3, the instructions 106, when executed by the at least one processor 102, cause the first device 10 to determine 204 a selected subset 20-SUBSET of the plurality 20-PLUR of transmitter devices 20a, 20b, 20c, . . . based on at least one of: a) a sub-region associated with a respective transmitter device, b) a frequency associated with a respective transmitter device. In some exemplary embodiments, this enables to perform a pre-selection of the plurality 20-PLUR of transmitter devices regarding the respective criteria.

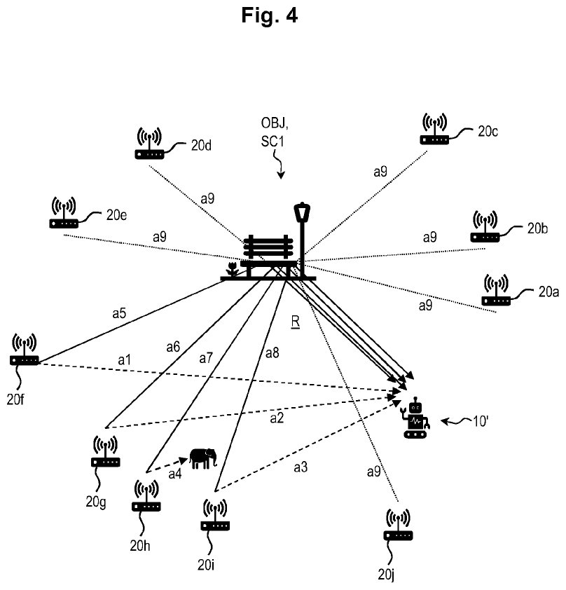

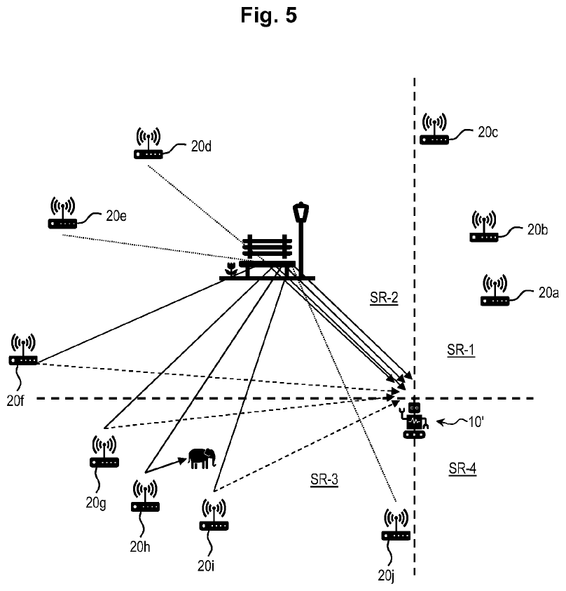

As an example, in some exemplary embodiments, see FIGS. 4 and 5, only some, e.g. certain, transmitter devices, but e.g. not all transmitter devices, e.g. base stations, within the region may see a specific object OBJ, e.g. scatterer SC1 (presently symbolized by a bench and a light pole), a position of which may, in some exemplary embodiments, be determined based on the radio frequency signals RFS (FIG. 2). Thus, in some exemplary embodiments, a decision metric may be used, e.g. defining which sub-regions of the region to be considered, e.g. scanned (e.g. for scattered radio frequency signals), e.g. for determining the position of the scatterer SC1.

In the exemplary embodiment of FIG. 4, ten transmitter devices 20a, 20b, 20c, . . . , 20j are depicted, wherein, as an example, only the transmitter devices 20f, 20g, 20i comprise a direct, i.e. line of sight, signal propagation path a1, a2, a3 (path a4 being blocked by a local obstacle) for radio frequency signals to the device 10′, which may e.g. be a mobile device such as a robot, and which may e.g. comprise the apparatus 100. In some exemplary embodiments, the device 10′ of FIG. 4, 5 may correspond with the first device 10 of FIG. 2.

Exemplary first order reflection-based signal propagation paths from the transmitter devices 20f, 20g, 20h, 20i to the robot 10′ are denoted with reference signs a5, a6, a7, a8, respectively.

In some embodiments, further exemplary signal propagation paths collectively denoted with reference sign a9 are depicted, e.g. from the transmitter devices 20a, 20b, 20c, 20d, 20e, 20j.

In some exemplary embodiments, capabilities of the transmitter devices such as e.g. a bandwidth and a frequency may determine, e.g. decide, how precise e.g. a related distance can be determined, e.g. estimated. Thus, in some exemplary embodiments, it is proposed to use an iterative metric, e.g. to predict a possible scanning precision for evaluating potentially scattered radio frequency signals RFS as may e.g. be received by the first device 10.

In some exemplary embodiments, FIG. 3, the instructions 106 (FIG. 1), when executed by the at least one processor 102, cause the first device 10 to determine 206 at least one distance 20-DIST associated with at least one of the plurality 20-PLUR of transmitter devices 20a, 20b, 20c, . . . , 20j based on channel information CI characterizing at least one radio channel associated with at least one of the plurality of transmitter devices.

In some exemplary embodiments, the determination 206 of the at least one distance 20-DIST associated with at least one of the plurality of transmitter devices may e.g. be based on channel state information, CSI, as may e.g. be provided and/or be evaluated according to some accepted standard. In other words, in some exemplary embodiments, distance estimations related to a respective distance between a respective transmitter device and the first device 10, 10′ may e.g. be made based on CSI associated with radio frequency signals RFS received by the first device 10, 10′ from the respective transmitter device.

In some exemplary embodiments, the determination 206 of the at least one distance 20-DIST associated with at least one of the plurality of transmitter devices may e.g. be characterized by the following equation

$${( F )}_{k , l} = {\sum }_{h = 0}^{H - 1} {b}_{h} {e}^{j 2 π {lT}_{O} {f}_{D , h}} {e}^{- j 2 π k {τ}_{h} Δ f} {e}^{j {φ}_{h}} + {( Z )}_{k , l} ,$$

wherein h characterizes a multipath component (e.g., a ray from transmitter to receiver), wherein H characterizes a maximum number of paths, wherein (F)_{k,l} characterizes channel state information associated with a k-th subcarrier and an l-th OFDM symbol, wherein (Z)_{k,l} characterizes additive white Gaussian noise at subcarrier k and symbol l, wherein bₕ characterizes an effective amplitude comprising information related to a path loss and reflection coefficients, wherein e^{jπlT}^{_{O}}^{f}^{_{D,h}} characterizes a phase shift over OFDM symbols due to movement (e.g., Doppler frequency f_{D}), wherein e^{-j2πkτ}^{ₕ}^{Δf} characterizes a phase shift over subcarriers with subcarrier spacing Δf, wherein e^{jφh} characterizes a random phase offset due to misalignment between a transmitter and a receiver.

In some exemplary embodiments, it can be seen that a range or distance causes a linear phase shift over subcarriers of the radio frequency signals, and the range or distance may e.g. be determined, e.g. estimated, over phase-shifts over the subcarriers. Note that in some exemplary embodiments, the distance may be impacted, e.g. by imperfect time synchronization, e.g. between one or more transmitter devices and a receiver 10-RX of the first device 10, 10′.

In some exemplary embodiments, FIG. 6, the instructions 106, when executed by the at least one processor 102, cause the first device 10, 10′ to perform at least one of: a) partitioning 210 the region R (FIG. 5) associated with the position of the first device 10, 10′ into a plurality of sub-regions, e.g. quadrants, e.g. four quadrants SR-1, SR-2, SR-3, SR-4 arranged around a reference position as e.g. defined by the position of the first device 10 or robot 10′, b) mapping 212 at least some transmitter devices of the plurality of transmitter devices to at least one sub-region (e.g., quadrant) of the plurality of sub-regions.

In some exemplary embodiments, quadrants SR-1, SR-2, SR-3, SR-4 may be created or defined by defining a reference point, e.g. focus point, in the first device 10, 10′, and by mapping the transmitter devices accordingly. In some exemplary embodiments, the procedure may involve one or more of the following aspects:
a) determine, e.g. calculate, distance vectors d=p−L.position, where L.position characterizes a position of a specific transmitter device, as e.g. comprised within a list L (FIG. 2) of transmitter devices, e.g. base stations,
b) map the transmitter devices to the different quadrants by quadrant 1: d.x>0 and d.y>0 (e.g., if a component d.x of the distance vector d is greater than zero and a component d.y of the distance vector d is greater than (or equal to) zero, assign the respective transmitter device to the first quadrant), quadrant 2: d.x<0 and d.y>0 (e.g., if the component d.x is less than zero and the component d.y is greater than zero, assign the respective transmitter device to the second quadrant), quadrant 3: d.x<0 and d.y<0 (e.g., if the component d.x is less than zero and the component d.y is less than zero, assign the respective transmitter device to the third quadrant), quadrant 4: d.x>0 and d.y<0 (e.g., if the component d.x is greater than zero and the component d.y is less than zero, assign the respective transmitter device to the fourth quadrant).

As an example, the exemplary transmitter devices 20a, 20b, 20c of FIG. 4, 5 may e.g. be mapped to the first quadrant SR-1 (FIG. 5), the exemplary transmitter devices 20d, 20e, 20f may e.g. be mapped to the second quadrant SR-2, the exemplary transmitter devices 20g, 20h, 20i, 20j may e.g. be mapped to the third quadrant SR-3.

In some exemplary embodiments, e.g. for scanning a certain quadrant, a list of quadrants +1 (e.g. 0-90° is quadrant 1) is used. Further within the list of quadrants, in some exemplary embodiments, a scanning method can be implemented by calculating corresponding angles alpha per reflection point and filtering, e.g. based on their quadrant matching (e.g. 0-90° is quadrant 1)

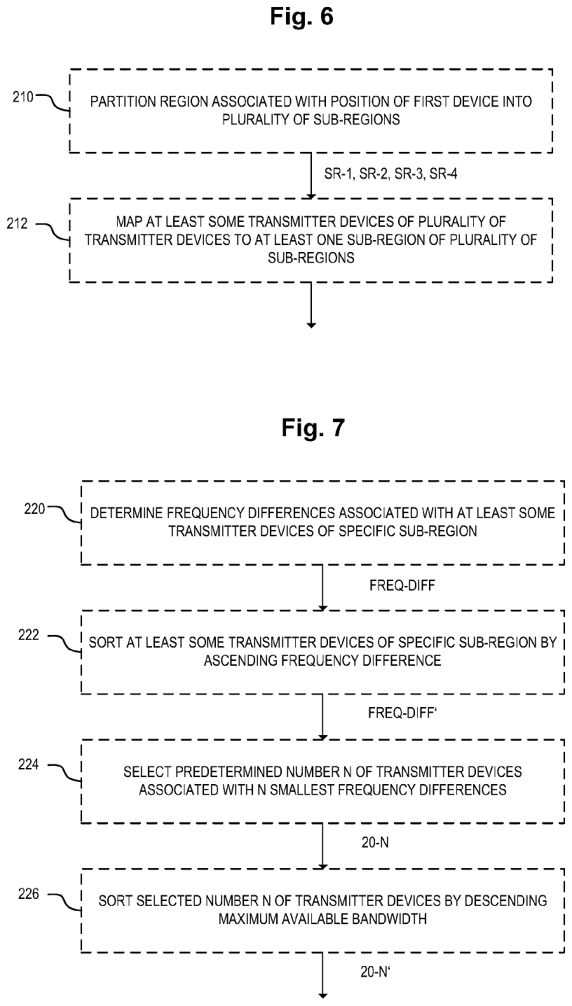

In some exemplary embodiments, FIG. 7, the instructions 106, when executed by the at least one processor 102, cause the first device 10, 10′ to perform at least one of: a) determining 220, for at least one sub-region (e.g., quadrant) of the plurality of sub-regions SR-1, SR-2, SR-3, SR-4, frequency differences FREQ-DIFF associated with at least some transmitter devices of the specific sub-region, b) sorting 222 the at least some transmitter devices of the specific sub-region by an ascending frequency difference (thus e.g. obtaining a sorted list FREQ-DIFF′ wherein a first entry of the sorted list corresponds with a minimum frequency difference), c) selecting 224 a predetermined number of N many transmitter devices associated with the N smallest frequency distances, whereby a selected predetermined number 20-N is obtained, d) sorting 226 the N many selected transmitter devices by a descending maximum available bandwidth (thus e.g. obtaining a sorted list 20-N′ wherein a first entry of the sorted list corresponds with the greatest maximum available bandwidth).

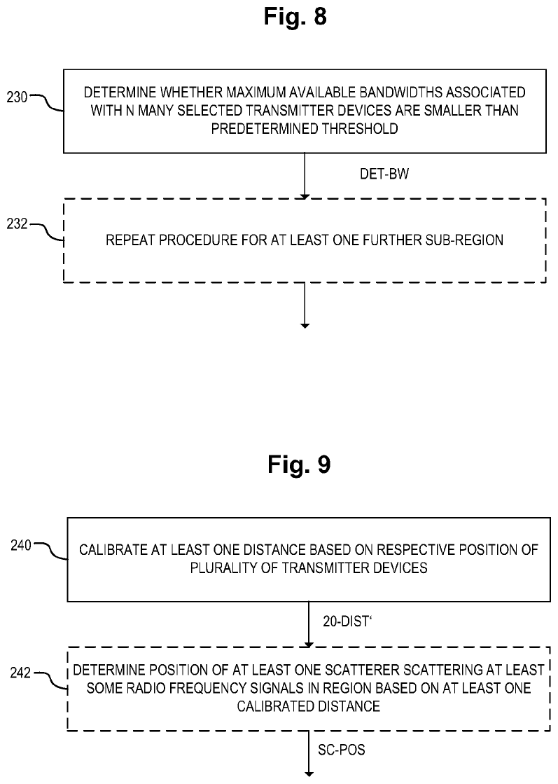

In some exemplary embodiments, FIG. 8, the instructions 106, when executed by the at least one processor 102, cause the first device 10, 10′ to determine 230 whether the bandwidths 20-N′ associated with the N many selected transmitter devices are smaller than a predetermined threshold bandwidth, which is e.g. associated with a desired spatial resolution, e.g. for determining a position of the scatterer SC1 (FIG. 4, 5). In some exemplary embodiments, a parameter m may be determined, e.g. according to m=bandwidth*spatial resolution/speed of light, wherein the parameter m characterizes whether the bandwidths associated with the N many selected transmitter devices are smaller than the predetermined threshold bandwidth with respect to the desired spatial resolution. In some exemplary embodiments, the determination DET-BW may e.g. be used to control aspects of an operation of the first device 10.

In some exemplary embodiments, FIG. 8, based on the determination DET-BW, e.g. if it is determined that the bandwidths associated with the N many selected transmitter devices are smaller than the predetermined threshold bandwidth with respect to the desired spatial resolution, at least some aspects 220, 222, 224, 224 (FIG. 7) of the procedure explained above for a first sub-region, e.g. quadrant, may e.g. be performed for at least one further sub-region, e.g. quadrant.

The process according to FIG. 8 enables to select transmitter devices the (potentially scattered) radio frequency signals of which may e.g. be used for determining the position of the scatterer SC1.

In some exemplary embodiments, FIG. 9, the instructions 106, when executed by the at least one processor 102, cause the first device 10 to calibrate 240 the at least one distance 20-DIST (FIG. 3) based on a respective position of the plurality of transmitter devices to obtain at least one calibrated distance 20-DIST′.

In some exemplary embodiments, the calibration 240 may be an in-situ calibration, e.g. comprising at least some of the following aspects:
a) providing the determined distances between a respective one of the N many selected transmitter devices and the first device 10,
b) using a technique based on a MUSIC (MUltiple SIgnal Classification) algorithm for estimating ranges of all taps (or, as an example, another technique for probing a noise subspace of a signal, e.g. by using a singular value decomposition (SVD)),
c) shifting a spectrum associated with the MUSIC algorithm by a first range to match the at least one distance 20-DIST,
d) providing a combination of distances as obtained from the preceding steps a), b), c), e.g. for a geometric reconstruction, e.g. for determining a position of the at least one scatterer SC1 scattering the radio frequency signals RFS.

In some exemplary embodiments, FIG. 9, the instructions 106, when executed by the at least one processor 102, cause the first device 10 to determine 242 a position SC1-POS (FIG. 2) of at least one scatterer SC1 scattering at least some of the radio frequency signals RFS in the region R based on the at least one calibrated distance 20-DIST′ (FIG. 9). In some exemplary embodiments, it is also possible to determine a position SC-POS of several, e.g. all, scatterers scattering at least some of the radio frequency signals RFS in the region R based on the at least one calibrated distance 20-DIST′.

In some exemplary embodiments, a first algorithm (“Algorithm 1”) may be used, e.g. for solving a nonlinear least-squares problem, e.g. via a gradient-descent based method, e.g. with various initializations, and a solution with the minimum related cost may be selected. In some exemplary embodiments, it is expected that Algorithm 1 may be tolerant with respect to noise.

In some exemplary embodiments, aspects of Algorithm 1 may be characterized by the expression

$${min}_{p} {\sum }_{i = 1}^{{N}_{TX}} {\vert f ( p , {t}_{i} , r , {d}_{i} ) \vert}^{2} ,$$

wherein the expression

$${\sum }_{i = 1}^{{N}_{TX}} {\vert f ( p , {t}_{i} , r , {d}_{i} ) \vert}^{2}$$

characterizes the related cost.

In some exemplary embodiments, a second algorithm (“Algorithm 2”) may be used, which may e.g. comprise at least some of the following aspects:
a) determine, e.g. analytically compute, an intersection of at least one pair of ellipses, e.g. of every pair of ellipses, associated with a potential scatterer,
b) determine NTX NTX−1 NSC2 candidate points, including NTX N2TX−1 points near a true position of each scatterer,
c) for at least some, e.g. every, candidate point, determine, e.g. compute, a cost for every possible range combination,
d) then, for NSC many times:
d1) pick a point p* with minimum cost c*
d2) return an average of p* and its NTX NTX−1−1 nearest neighbors.

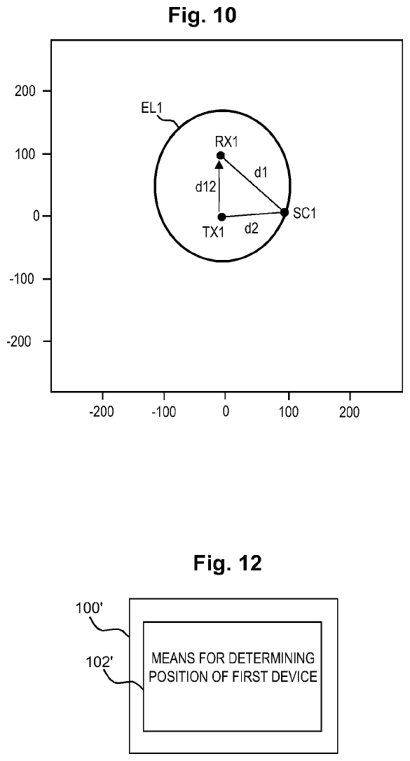

In this respect, for illustrative purposes, FIG. 10 schematically depicts an exemplary single ellipse EL1 associated with an estimated range of a scatterer SC1 e.g. scattering the radio frequency signals RFS of FIG. 2. In FIG. 10, element TX1 symbolizes a first transmitter device, e.g. similar to transmitter device 20a of FIG. 2, element RX1 symbolizes a receiver, which may e.g. represent the receiver RX of the first device 10, and the ellipse EL1 symbolizes points of potential radio frequency signal propagation paths originating from the transmitter TX1, passing the scatterer SC1, and reaching the receiver RX1. Distance segments d1, d2 of one exemplary radio frequency signal propagation path having an overall length d are symbolized in FIG. 10.

The basic principle illustrated by FIG. 10 according to some exemplary embodiments can, according to further exemplary embodiments, be used for reconstructing the scattering locations, e.g. positions of one or more scatterers SC1 (FIG. 2) in the region R.

As an example, the receiver RX1 may receive both over the direct path d12 and the “reflected” (i.e., scattered) path d1, d2 two times the same radio frequency signal of the transmitter TX1. In some exemplary embodiments, the receiver RX1 can estimate the distances d12, d1+d2, and so the ellipse EL1 on which the potential scatterer SC1 could lie may be determined.

In further exemplary embodiments, e.g. if at least one further transmitter (not shown in FIG. 10) is added, a further ellipse (not shown) may be determined, and e.g. two intersections of the two ellipses may be determined, e.g. further reducing the problem of determining the position of the scatterer SC1.

In further exemplary embodiments, using the principle according to the embodiments, one or more of the following aspects may be addressed, e.g. enabling to determine a position of one or more scatterers SC1 based on radio frequency signals RFS received by the first device:
a) how to select a proper set of transmitter devices 20a, 20b, . . . (FIG. 4, 5), e.g. under consideration of a mobile device 10′,
b) how to estimate the distances between the transmitter devices (and/or the first device 10, 10′) in a reliable fashion, and e.g. without synchronization,
c) how to handle issues of a line of sight (LoS) path being blocked, see arrow a4 of FIG. 4,
d) how to handle more than one reflection/scattered radio frequency signal,
e) how to handle computational complexity,
f) how to handle mobility of the first device 10 or robot 10′ and/or of the scatterer SC1,
g) how to handle asynchronous transmissions of different transmitter devices 20a, 20b, 20c, . . . .

Thus, some exemplary embodiments enable to provide a, for example unified, passive and opportunistic method to determine, e.g. re-create, geometric features, e.g. main geometric features, of an environment (as e.g. characterized by one or more scatterers SC1), e.g. using the propagation of the radio frequency signals RFS provided by the transmitter devices, e.g. exploiting an option of in-situ calibration methods and/or, e.g. smartly, selecting or pre-selecting transmitter devices, e.g. base stations.

In some exemplary embodiments, a mobile user associated with the first device 10 (FIG. 2) may e.g. gather (by means of the first device 10) available radio transmissions around him, e.g. in the form of the radio frequency signals RFS. In some exemplary embodiments, information such as e.g. multi-path components may be used, e.g. to reconstruct geometric features in the region R around him, the geometric features e.g. being characterized by one or more scatterers SC1 scattering at least a portion of the radio frequency signals RFS.

In some exemplary embodiments, a mobile device comprising the apparatus 100 may e.g. listen passively (e.g., without communication) to the radio frequency signals RFS.

In some exemplary embodiments, the radio frequency signals RFS may e.g. comprise reference signals, e.g. of the surrounding transmitter devices 20a, 20b, 20c, . . . , e.g. base-stations, e.g. according to some accepted standard (e.g., sounding reference signals and the like), which may e.g. be used or exploited, e.g. to “scan” the environment or region R around the mobile device.

In some exemplary embodiments, a procedure to exploit multi-path component information comprised within the radio frequency signals RFS may evolve as follows: Determining the closest transmitter devices, e.g. base stations (and their positions), e.g. around the first device 10, optionally pre-selecting a best (e.g., according to at least one predetermined criterion) set of transmitter devices, listening on corresponding channels, performing an optional in-situ-(e.g., online) calibration, optionally removing outlier(s), e.g. based on a path-loss, reconstructing, e.g. from determined distances 20-DIST, the position(s) of the scatterers.

In some exemplary embodiments, multi-path components of the radio frequency signals RFS may be employed, e.g. exploited, e.g. to reconstruct an environment in the region R (FIG. 2), e.g. without any assumptions regarding a geometry and/or a pre-defined cumbersome fingerprinting map. Some conventional approaches for reconstructing an environment may require a comparatively large amount of e.g. pre-measured fingerprints, e.g. to do a virtual transmitter reconstruction, which may e.g. be infeasible in changing environments, e.g. outdoors.

Advantageously, the principle according to the embodiments does not rely on pre-measured fingerprints.

Further advantageously, the principle according to the embodiments does not rely on multiple angle-of-arrival and high precision calibration methods as required by some conventional approaches.

Further advantageously, the principle according to the embodiments does not require a large amount of computational resources so that it is well-suited for mobile applications, e.g. for UE of wireless communication systems 1000.

The principle according to the embodiments e.g. enables to leverage the abovementioned multi-path components of radio frequency signals originating from multiple transmitter devices, e.g. processing them, e.g. jointly, e.g. to reconstruct a surrounding environment, e.g. in a flexible, low energy, and robust way, e.g. well-suited for mobile outdoor devices.

In some exemplary embodiments, one or more aspects of at least some embodiments may at least temporarily be off-loaded from the apparatus 100 or the first device 10 or robot 10′, respectively, e.g. to a cloud, e.g. edge cloud, EC (FIG. 2), thus further reducing a required power on the device 100, 10, 10′.

In some exemplary embodiments, FIG. 4, 5, e.g. in outdoor scenarios with fast-moving devices 10′, a latency of e.g. sensors may be important and thus, the principle according to the embodiments, which may e.g. be applied locally within the device 10′, allows information to be used locally, e.g. for localization and/or tracking.

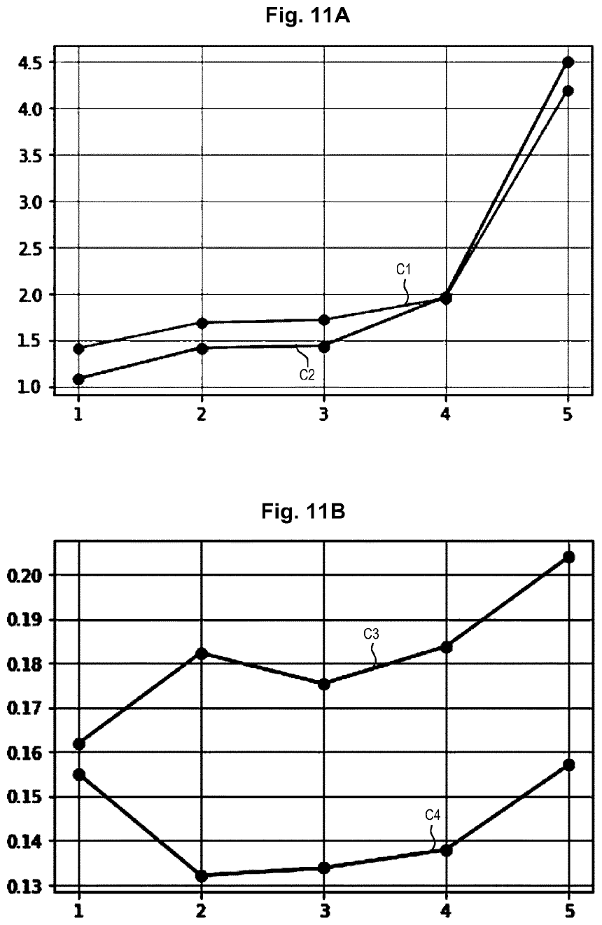

FIG. 11A, 11B, 11C, 11D each schematically depicts a simplified diagram according to some embodiments.

Curve C1 symbolizes a distance error in m over a number of scattering points for an intersection method, e.g. before calibration. Curve C2 symbolizes a distance error in m over the number of scattering points for a least squares method, e.g. before calibration. Curve C3 symbolizes a distance error in m over the number of scattering points for the intersection method after calibration. Curve C4 symbolizes a distance error in m over the number of scattering points for the least squares method after calibration.

Further exemplary embodiments, FIG. 12, relate to an apparatus 100′ comprising means 102′ for determining 200 (FIG. 3), by a first device 10 (FIG. 2), a position 10-POS of the first device 10, and for determining 200, by the first device 10, a plurality 20-PLUR of transmitter devices 20a, 20b, 20c, . . . configured to transmit radio frequency signals RFS in a region R associated with the position 10-POS of the first device 10. In some exemplary embodiments, the means 102′ for determining, by the first device, a position of the first device, and for determining, by the first device, a plurality of transmitter devices configured to transmit radio frequency signals in a region associated with the position of the first device may e.g. comprise at least one processor 102, and at least one memory 104 storing instructions 106, the at least one memory 104 and the instructions 106 configured to, with the at least one processor 102, cause the first device 10 to determine a position of the first device, and to determine a plurality of transmitter devices configured to transmit radio frequency signals in a region associated with the position of the first device.

Further exemplary embodiments relate to a mobile device 10′ (FIG. 4, 5) comprising at least one apparatus 100 (FIG. 1), 100′ (FIG. 12) according to the embodiments.

Further exemplary embodiments, FIG. 3, relate to a method comprising: determining 200, by a first device 10, a position 10-POS of the first device 10, and determining 202, by the first device 10, a plurality 20-PLUR of transmitter devices configured to transmit radio frequency signals RFS in a region R associated with the position of the first device.

Further exemplary embodiments, FIG. 2, relate to a system 1000 comprising at least one of: a) an apparatus 100, 100′ according to the embodiments, b) at least one transmitter device 20a, 20b, 20c, . . . configured to transmit radio frequency signals RFS in the region R associated with the position of the first device.

In some exemplary embodiments, the system 1000 is a wireless communications system, wherein the apparatus 100, 100′ is associated with or configured as a terminal device (e.g., UE) for the wireless communications system, and wherein the at least one transmitter device is at least one of a) a network device (e.g., base station, e.g. gNB) and b) a terminal device (e.g., UE) for the wireless communications system 1000.

Further exemplary embodiments relate to a computer program or computer program product comprising instructions 106 (FIG. 1) which, when the program is executed by a computer (e.g., comprising the processor 102), cause the computer to carry out the method according to the embodiments.

Further exemplary embodiments, FIG. 1, relate to a data carrier signal DCS carrying and/or characterizing the instructions 106 according to the embodiments, wherein the instructions 106 may e.g. be provided in the form of at least one computer program.

1. An apparatus, comprising:
at least one processor; and
at least one memory storing instructions that, when executed with the at least one processor, cause a first device to:
determine a position of the first device; and
determine a plurality of transmitter devices configured to transmit radio frequency signals in a region associated with the position of the first device.

2. The apparatus according to claim 1, wherein determining the plurality of transmitter devices comprises determining a respective position of the plurality of transmitter devices.

3. The apparatus according to claim 1, wherein the instructions, when executed with the at least one processor, cause the first device to determine a selected subset of the plurality of transmitter devices based on at least one of: a sub-region associated with a respective transmitter device or a frequency associated with a respective transmitter device.

4. The apparatus according to claim 1, wherein the instructions, when executed with the at least one processor, cause the first device to determine at least one distance associated with at least one of the plurality of transmitter devices based on channel information characterizing at least one radio channel associated with at least one of the plurality of transmitter devices.

5. The apparatus according to claim 1, wherein the instructions, when executed with the at least one processor, cause the first device to perform at least one of: partitioning the region associated with the position of the first device into a plurality of sub-regions mapping at least some transmitter devices of the plurality of transmitter devices to at least one sub-region of the plurality of sub-regions.

6. The apparatus according to claim 5, wherein the instructions, when executed with the at least one processor, cause the first device to perform at least one of: determining, for at least one sub-region of the plurality of sub-regions, frequency differences associated with at least some transmitter devices of the specific sub-region, sorting the at least some transmitter devices of the specific sub-region by with an ascending frequency difference, selecting a predetermined number of N many transmitter devices associated with the N smallest frequency distances, r sorting the N many selected transmitter devices by with a descending maximum available bandwidth.

7. The apparatus according to claim 6, wherein the instructions, when executed with the at least one processor, cause the first device to determine whether the bandwidths associated with the N many selected transmitter devices are smaller than a predetermined threshold bandwidth.

8. The apparatus according to claim 4, wherein the instructions, when executed with the at least one processor, cause the first device to calibrate the at least one distance based on a respective position of the plurality of transmitter devices to obtain at least one calibrated distance.

9. The apparatus according to claim 8, wherein the instructions, when executed with the at least one processor, cause the first device to determine a position of at least one scatterer scattering at least some of the radio frequency signals in the region based on the at least one calibrated distance.

10. (canceled)

11. A mobile device comprising at least one apparatus according to claim 1.

12. A method, comprising:
determining, with a first device, a position of the first device; and
determining, with the first device, a plurality of transmitter devices configured to transmit radio frequency signals in a region associated with the position of the first device.

13. A system comprising at least one of: an apparatus according to claim 1 or at least one transmitter device configured to transmit radio frequency signals in the region associated with the position of the first device.

14. The system of claim 13, wherein the system is a wireless communications system, wherein the apparatus is associated with or configured as a terminal device for the wireless communications system, and wherein the at least one transmitter device is at least one of a network device or a terminal device for the wireless communications system.
